(19) United States
(12) Patent Application Publication
(10) Pub. No.: US 2012/0176480 A1
(43) Pub. Date: Jul. 12, 2012

(54) Portable Device Having Self-Image Generating Module

(76) Inventor: Kuo-Ching CHIANG, New Taipei City (TW)

(21) Appl. No.: 13/421,479

(22) Filed: Mar. 15, 2012

Related U.S. Application Data
(63) Continuation of application No. 12/942,649, filed on Nov. 9, 2010.

(51) Int. Cl. H04N 13/02; H04N 7/18; H04N 5/225

(52) U.S. Cl. 348/47; 348/333.01; 348/218.1; 348/78; 348/E13.074; 348/E07.085; 348/E05.024

(57) ABSTRACT

A portable communication device having self image generating module for displaying self-image, comprises a control unit, a first communication module coupled to the control unit; a display coupled to the control unit and formed on a front side of the portable communication device. An image capture module is coupled to the control unit and being set on a rear side of the portable communication device to facilitate to capture stereo image. A self-image generating module is coupled to the control unit and being formed on the front side of the portable communication device to capture user self image. A display segmentation unit is coupled to the control unit to divide the display into at least area to display a receiving image of communication party and self image captured by the self-image generating module.

### CROSS-REFERENCE TO RELATED APPLICATION

This application is a Continuation Application of an application Ser. No. 12/942,649, filed on Nov. 9, 2010, entitled “Portable Device Having Stereo-image Capturing Module”, now pending. The contents of the above-mentioned patent application is hereby incorporated by reference herein in its entirely and made a part of this specification.

### FIELD OF THE INVENTION

The present invention generally relates to a portable device, especially to a portable communication device with a self-image generating module.

### DESCRIPTION OF THE PRIOR ART

In pace with the development of IT (information technology), information can be exchanged with higher speed and greater capacity. The third generation mobile protocol can make users enjoy diverse services, and immediately information exchange is executable such that live broadcast can be watched via the mobile communication internet or the Internet. However, there is no portable communication device capable of generating stereo images.

### SUMMARY OF THE INVENTION

The present invention provides a method for a portable communication device to play stereo image, the steps are described as follows: At first, the portable communication device with a stereo image capture module is provided, wherein the portable communication device includes a control unit, a first communication module coupled to the control unit, a display coupled to the control unit; the stereo image capture module being coupled to the control unit to facilitate to capture stereo image, and a stereo image generation module coupled to the control unit for generating stereo image from data received from the stereo image capture module, wherein the stereo image generation module can be stored in a remote computer, a remote server, or the portable communication device, wherein the stereo image capture module comprises two image capture elements arranged linearly with a distance; and then, two images are captures by the stereo image capture module; and next, a stereo image is generated from the captured two images by the stereo image generation module, and finally, the stereo image is stored.

In another aspect, a portable communication device with a stereo image capture module is disclosed, which includes: a control unit, a display coupled to the control unit, a stereo image capture module coupled to the control unit to facilitate to capture stereo image, and a stereo image generation module coupled to the control unit for generating stereo image from data received from the stereo image capture module. The stereo image capture module comprises two image capture elements arranged linearly with a distance approximate to the distance between two pupils of human, and those image capture elements comprise CMOS or CCD and can be arranged parallel to the major axis of the portable communication device.

A short range wireless internet module can be further included, which comprises Wi-Fi module, or 802.11 module, wherein a WiMAX (Worldwide Interoperability for Microwave Access) module can also be introduced.

A portable communication device having self image generating module for displaying self-image, comprises a control unit, a first communication module coupled to the control unit; a display coupled to the control unit and formed on a front side of the portable communication device. An image capture module is coupled to the control unit and being set on a rear side of the portable communication device to facilitate to capture stereo image. A self-image generating module is coupled to the control unit and being formed on the front side of the portable communication device to capture user self image. A display segmentation unit is coupled to the control unit to divide the display into at least two areas to display a receiving image of communication party and self image captured by the self-image generating module.

A portable device having self image generating module for displaying self-image, comprises a control unit; a display coupled to the control unit and formed on a first side of the portable communication device; an image capture module coupled to the control unit and being set on a second side of the portable device to facilitate to capture image. A self image generating module having sensor is coupled to the control unit and the sensor is formed on the first side of the portable device to capture user-self image; wherein a user of the portable device captures user-self image by using the self image generating module having sensor at the first side with the display to allow the user see user-self image from the display when user-self image capturing.

The portable device comprising a multi-tasking module coupled to the control unit, a display segmentation unit coupled to the control unit to divide the display into at least two areas to display a receiving image of communication party and self image captured by the self-image generating module.

### BRIEF DESCRIPTION OF THE DRAWINGS

FIG. 1 shows the diagram of the present invention.

FIG. 2 shows the embodiment of the present invention.

FIG. 3 shows the embodiment of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a digital photo frame, or a notebook, etc. The following embodiment is just to illustrate rather than limiting the present invention.

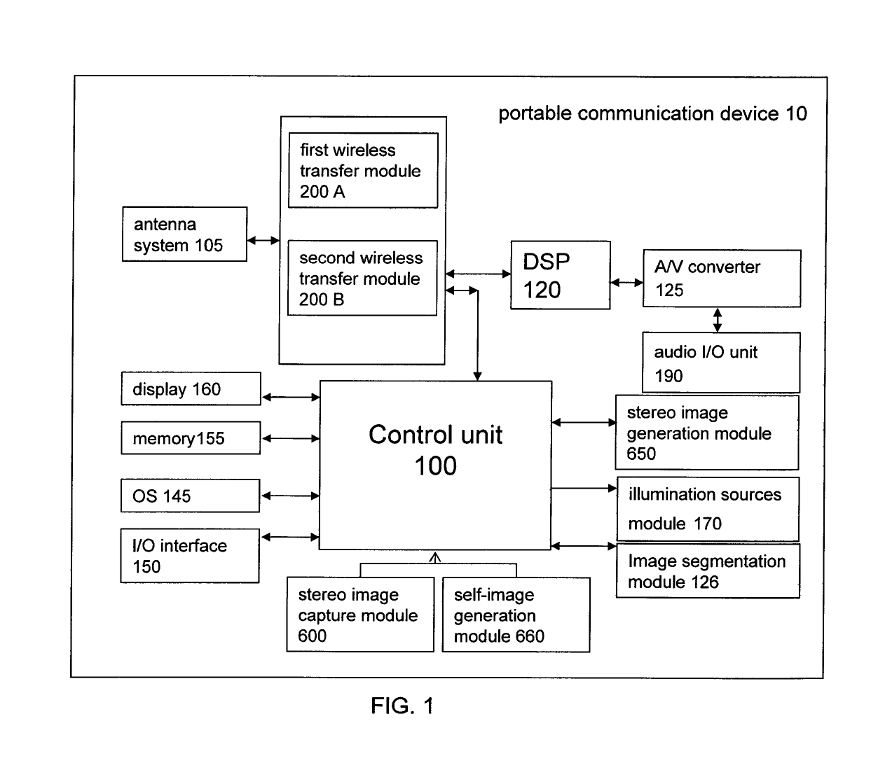

FIG. 1 exhibits a functional diagram of the portable communication device 10 with a stereo image capture module. If the portable communication device is a cell phone, it may comprise the SIM card connector for carrying the SIM card, which is well known in the art, and hence it will not be described redundantly hereinafter. In other types of cell phones, such as PHS or some CDMA systems, the SIM card is not certainly necessary. The figure is introduced to explain rather than limiting the present invention. The portable communication device 10 includes a wireless data transfer module 200A, which can be a video RF module for transmitting or receiving mobile signals, and aforementioned module is well known by skilled persons in the art. As well known, the RF module is coupled to an antenna system 105, which may be single or multiple antennas according to demands, and it may further include the base band processor. The antenna system is connected to a radio transceiver for transmitting or receiving signals. The wireless data transfer module 200A is compatible with various mobile communication protocols, such as W-CDMA, CDMA2000, CDMA2001, TD-CDMA, TD-SCDMA, UWC0136, DECT, or 4G systems. These systems allow users to communicate through video telephone. The RF module may be introduced to perform transmitting and receiving of signals, frequency synchronization, base band processing, and digital signals processing, etc. The hardware interface of SIM card is used to contain (or insert) a SIM card. And finally, signals can be transmitted to the final actuators, that is, the audio I/O (input/output) unit 190. However, if the portable communication device is not a cell phone, aforementioned elements are not indispensable.

The portable communication device 10 may include a DSP (digital signal processor) 120 and/or a central control unit 100, encoder/decoder (not shown) and A/V converter 125, and the arrangement of those elements can be determined based on applications. The portable communication device 10 further comprises a display 160, OS (operation system) 145, and memory 155, wherein the memory 155 includes ROM, RAM, and nonvolatile FLASH memory. Aforementioned units can be coupled to the central control unit 100 respectively or the DSP 120. Aforementioned memory can be nonvolatile memory, micro-disk. The cable I/O interface 150 is coupled to the central control unit 100, and it may be USB or IEEE 1394.

The portable communication device 100 may also include a second wireless data transfer module 200B, which may comply with a communication protocol with communication distance shorter than the first wireless data transfer module 200A, such as WiFi, or WiMax, etc. In an embodiment, a wireless short range (local) internet module can be introduced, and LAN, MAN (metropolitan area network), or other network, such as Wi-Fi or 802.11x (x means a, b, g, n), are also compatible in the present invention. “Short range” represents that communication distance is shorter than the mobile communication distance. Further, the wireless local network module may be compatible with the WiMAX or standard protocol. And users can connect internet or hot spots via WiFi or WiMax.

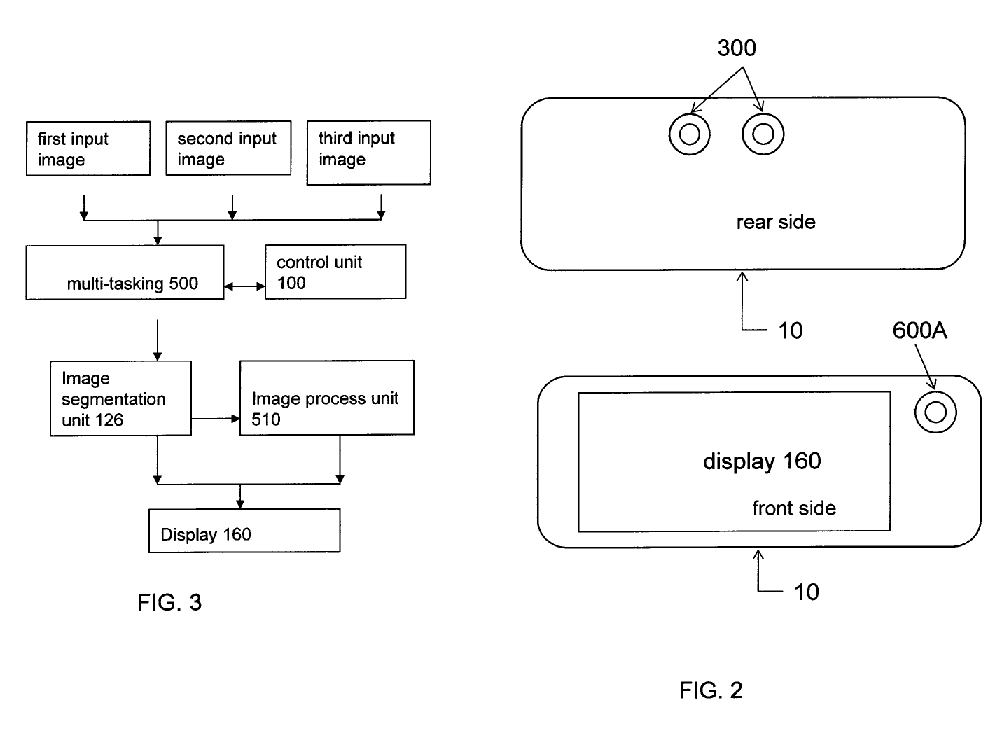

The stereo image capture module 600 and stereo image generation module 650 are coupled to aforementioned DSP 120 or/and the central control unit 100. The stereo image capture module 600 includes a least two image capture elements with a distance and corresponded lens (referred to FIG. 2). The image sensors 600 are set in the rear side without the display of the portable device. The image capture elements can be CMOS, or CCD with a plurality of micro-meniscus configured thereon for facilitating light concentrating and stereo imaging, and the preferable distance between them is the distance between two pupils of human. Objects directly observed by human beings can be simulated by two separated image capture elements, and therefore, images with parallax can be generated due to the simultaneously captured images form different viewing angle. Those two image capture elements are preferably arranged along the major axis of the portable communication device. After two captured images are stored, the images can be processed by the stereo image generation module 650 to generate similarly or virtually stereo image, such that it can benefit producing stereo images, photos, stereo table-cloth on the screen, stereo images used for the address book, etc. The stereo images can be synthesized by a left image and a right image. The imaging process may also include zooming, rotating, translating, swapping left and right images, trimming, smoothing display by noise reduction, and so on. It's much better if the 3D display can be introduced, such as Sharp's Auto3D LCD, Horizontal Interleaved 3D Display, ex: vRex microPol 3D LCD, or Vertical Interleaved 3D LCD, ex: DTI, Pavonine. A stereo display is also disclosed in the United States patent application numbered 2009015365. JPS Builder synthesize technology, such as the synthesize technology developed by Texnai Incorporate, can be applied to rebuild stereo images, and aforementioned technology is recited herein as an example rather than limiting the present invention. The stereo images generated by the portable communication device can also be uploaded to websites, blogs, or other devices through the first wireless data transfer module 200A and the second wireless data transfer module 200B, and that is direct and convenient because the computer and the memory card are not required. The stereo image generation module 605 can also configured at the remote terminal, and images captured by the stereo image capture module 600 can be transferred to remote terminal to be processed via connection between remote computers or servers and the first wireless data transfer module 200A or the second wireless data transfer module 200B; or after connected, the stereo image generation module 650 can be activated by the portable communication device 10 to execute stereo images processing procedure, and the processed stereo image can be stored in remote computers, servers or the portable communication device 10.

The user image data captured by the image capture device 600 can be transformed to digital data, and the digital data can be formed to be data stream via composed, compressed, or processed. Self-images can be generated by the self-image generation module 660, followed by displaying on the display 160 immediately. For example, the user can see his self-image by the mirror image or the image after adjusted, wherein the display and the image sensor and lens 600A of the self-image generation module 660 are arranged at the same side. By aforementioned features, aspects, teaching, optical theory, and photograph imaging theory, users are able to see the self-image when making a photo instead of just seeing the object to be taken, and meanwhile, the displayed image can be mirror image. Because the displayed image is dynamic and simultaneous, it's convenience for the user to use the present invention as a virtual mirror. To facilitate to watch the self-image, the display and the lens, image sensor of the self-image generation module 660 must be at the same side, namely, both the lens and the display must face the user. When the user desires to use a mirror to comb, dress, or apply lipstick, if there is no mirror around, the present invention can provide convenience in place of the mirror. And the user doesn't need to carry the mirror in accompaniment. Aforementioned self-image generation module 660 can be performed by using software, firmware, or computer readable commands, and there is great amount application software for generating images nowadays, and there are also many programs for displaying images in the digital camera. And other image software, such as photo-impact, photoshop can also used to generate images.

To benefit applications of the present invention, single or multi-illumination sources module 170 coupled to the control unit 100 is introduced for generating mirror image under dusky or dark circumstance. A choice interface is coupled to the multi-illumination sources module to facilitate to choose modes. A light sensor is coupled to the multi-illumination sources module. When the light intensity is less than a predetermined level, the control unit will activate the multi-illumination sources module based on the detected signals of the light sensor, thereby providing desired light for video communication or taking a photo. One mode of the multi-illumination sources may be night vision mode such as IR (infrared) mode, which enables the user to take photo under dark circumstance. Aforementioned illumination module comprises IR device or LED. Further, the illumination module comprises a xenon illumination device. For example, the gas is mixed, and the main component is nitrogen and a certain amount of argon, neon, xenon or krypton is introduced for providing a catalyst for nitrogen being ionized. The user can choose appropriate illumination according to different situations and different purposes, and the feature is that the present invention can be executed under dusky or dark circumstance.

The portable communication device 10 comprises an image segmentation unit 126 coupled to the control unit 100 for simultaneously dividing the display areas on the display for display multiple images including the receiving image of the communication party and the self image capture by the self image generating module 600. The process of dividing display areas can be referred to the U.S. Pat. Nos. 7,171,019 and 7,142,689 filed by Canon Kabushiki Kaisha, and the U.S. Pat. No. 7,059,729 filed by Hitachi Ltd. The multipoint videoconference can be achieved by aforementioned feature. The received images will be assigned to the divided areas which may be separated, overlapped, or partially overlapped. Referred to FIG. 3, a plurality of input images are transferred to multi-tasking module 500 for processing received images form a plurality of terminals. Before the image data signals transmitted to the display 160, aforementioned images are previously processed by the image segmentation unit 126. The image process unit 510 can be introduced to adjust the processed image before being displayed. The task multitasking 500 refer to a method where multiple tasks (also known as processes) share common processing resources such as a CPU. Multitasking solves the one process one task problem by scheduling which task may be the one running at any given time, and when another waiting task gets a turn. The multi-tasking allow reassign the control unit from one task to another different task to achieve parallelism or context switches. Thus, the different task multi-tasking module may reassign the control unit to switch from one process to another different process to facility context switches.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A portable communication device having self image generating module for displaying self-image, comprising
a control unit;
a first communication module coupled to said control unit;
a display coupled to said control unit and formed on a front side of said portable communication device;
an image capture module coupled to said control unit and being set on a rear side of said portable communication device to facilitate to capture image;
a self image generating module having sensor coupled to said control unit and being formed on said front side of said portable communication device to capture user self image;
a display segmentation unit coupled to said control unit to divide said display into at least two areas to display a receiving image of communication party and self image captured by said self-image generating module.

2. The portable communication device according to claim 1, wherein said image capture module includes two image CMOS or CCD.

3. The portable communication device according to claim 2, wherein said two image CMOS or CCD are arranged parallel to a major axis of said portable communication device.

4. The portable communication device according to claim 3, wherein said distance approximates distance between two pupils of a human.

5. The portable communication device according to claim 2, further comprising a stereo image generating module coupled to said control unit.

6. The portable communication device according to claim 1, further comprising a second communication module.

7. The portable communication device according to claim 6, wherein said second communication module includes Wi-Fi module or 802.11 module.

8. The portable communication device according to claim 6, wherein said second communication module includes WiMAX (Worldwide Interoperability for Microwave Access) module.

9. The portable communication device according to claim 1, further comprising a multi-tasking module coupled to said control unit.

10. A portable device having self image generating module for displaying self-image, comprising
a control unit;
a display coupled to said control unit and formed on a first side of said portable communication device;
an image capture module coupled to said control unit and being set on a second side of said portable device to facilitate to capture image;
a self image generating module having sensor coupled to said control unit and said sensor being formed on said first side of said portable device to capture user-self image; wherein a user of said portable device captures user-self image by using said self image generating module having sensor at the first side with said display to allow said user see user-self image from said display when user captures user self image.

11. The portable device according to claim 10, further comprising a multi-tasking module coupled to said control unit.

12. The portable device according to claim 10, further comprising a display segmentation unit coupled to said control unit to divide said display into at least two area to display a receiving image of communication party and self image captured by said self-image generating module.

13. The portable device according to claim 10, wherein said image capture module includes two image CMOS or CCD.

14. The portable device according to claim 13, wherein said two image CMOS or CCD are arranged parallel to a major axis of said portable communication device.

15. The portable device according to claim 14, wherein said distance approximates distance between two pupils of a human.

16. The portable device according to claim 13, further comprising a stereo image generating module coupled to said control unit.
